(19) United States
(12) Patent Application Publication
(10) Pub. No.: US 2012/0076596 A1
(43) Pub. Date: Mar. 29, 2012

(54) Reversible Cutting Insert and Tool Assembly Having the Same

(75) Inventor: Dong Seob Kim, Daegu (KR)

(73) Assignee: TaeguTec, Ltd., Dalsung-gun (KR)

(21) Appl. No.: 13/309,821

(22) Filed: Dec. 2, 2011

Related U.S. Application Data
(63) Continuation-in-part of application No. PCT/KR2009/002926, filed on Jun. 2, 2009.

(51) Int. Cl. B23C 5/02; B23C 5/14; B26D 1/12

(52) U.S. Cl. 407/69; 407/113

(57) ABSTRACT

A reversible cutting insert has an upper face, a lower face, a central axial hole and a plurality of side faces connecting the upper face and the lower faces, each of the side faces being convexed in the lateral direction. Round-shaped upper and lower cutting edges are formed at a border portion between the upper face and each of side faces and a border portion between the lower face and each of the side faces, respectively, each of the side faces having an axially dented portion formed between the upper cutting edge and the lower cutting edge, the axially dented portion extending in a widthwise direction and having a flat face perpendicular to the upper and lower faces. A tool assembly according to the present invention includes a tool holder on which a plurality of pockets are formed, and a plurality of cutting inserts, each of which is mounted in one of the pockets.

### RELATED APPLICATIONS

This is a Continuation-in-Part of International Patent Application No. PCT/KR2009/002926, filed Jun. 2, 2009 and published as WO 2010/140718A1 on Dec. 9, 2010. The contents of the aforementioned application are incorporated by reference in its entirety.

### TECHNICAL FIELD

The present invention relates to a cutting insert and a tool assembly comprising the same, more particularly, to a cutting insert having a plurality of cutting edges formed thereon, and a tool assembly comprising the above cutting insert and a tool holder on which the cutting inserts can be mounted securely and stably.

### BACKGROUND ART

In general, a ball nose end mill is an equipment utilized for machining an appearance of a workpiece having a rounded shape. The ball nose end mill comprises a spherical shaped tool holder and a shank coupled to the tool holder.

FIG. 1 is a partial perspective view of a conventional ball nose end mill and illustrates a tool assembly 10 constituting the ball nose end mill. The tool assembly 10 comprises a spherical tool holder 11 as described above and a plurality of non-reversible, or “single-sided” cutting inserts 12, each of which is mounted in a pocket formed on the tool holder 11. The structure of the tool holder 11 and the cutting insert 12 mounted to the tool holder 11 are briefly illustrated with reference to FIG. 2 and FIG. 3.

FIG. 2 is a perspective view of the cutting insert 12 shown in FIG. 1, the hexahedral cutting insert 12 has an upper face 12-5, a lower face 12-6 and four side faces 12-1, 12-2, 12-3 and 12-4. A cross sectional area of the cutting insert 12 is gradually reduced toward the lower face 12-6. As a result, four side faces 12-1, 12-2, 12-3 and 12-4 of the cutting inserts 12 are the inclined faces inclined toward a through hole 12-7 formed on a central portion. The cutting insert 12 having the structure as described above has two cutting edges e1 and e2 formed on both side ends of the upper face 12-5.

FIG. 3 is a sectional view taken along the line A-A in FIG. 1 and shows one pocket 14 formed on the tool holder 11 and one cutting insert 12 mounted in the pocket 14. For convenience' sake, in the meantime, the cutting insert 12 which is not in section is illustrated in FIG. 3.

The pocket 14 formed on the tool holder 11 has a shape which is similar to that of the cutting insert 12, and one side corresponding to an operative cutting edge (e1 shown in FIG. 3 for cutting the workpiece) of the cutting insert 12 is opened and is adjacent to a groove 14-1 having a certain width, length and depth.

When the cutting insert 12 is mounted in the pocket 14 of the tool holder 11, the lower face 12-6 and three side faces 12-1, 12-3 and 12-4 are in contact with a bottom face and three side walls of the pocket 14, one side face 12-2 corresponding to the cutting edge e1 is adjacent to the groove 14-1 formed at an outside of the pocket 14.

The cutting insert 12 and the pocket 14 having the above-illustrated structures cause the problems described below.

As shown in FIG. 2 and FIG. 3, the cutting insert 12 has two cutting edges e1 and e2 formed at border portions between the upper face 12-5 and the second side face 12-2 and between the upper face 12-5 and the fourth side face 12-4. Accordingly, in a case where two cutting edges e1 and e2 are worn out, the cutting insert 12 should be separated and removed from the tool holder 11 and new cutting insert should be then mounted to the tool holder 11. In particular, since the cutting insert 12 has a shape in which a cross section area is gradually reduced toward the lower face 12-6, the cutting insert 12 can not be reversed and mounted in the pocket 14 in a state where the upper face 12-5 is placed on a bottom face of the pocket 14, and so the edge portions of the lower side face 12-6 can not be utilized as the cutting edge.

In the meantime, as shown in FIG. 3, three side walls constituting the pocket 14 formed on the tool holder 11 are parallel to a central line of the through hole 12-7 of the cutting insert 12, that is, a central line of the clamping screw 13, and the side faces 12-1, 12-3 and 12-4 of the cutting insert 12 are inclined faces which are inclined with respect to a central line of the through hole 12-7. Accordingly, when the cutting insert 12 is mounted in the pocket 14 of the tool holder 11, the side face (12-4 in FIG. 3) of the cutting insert 12 is not surface-contacted completely with the side wall (14-4 in FIG. 3) of the pocket 14; only a small portion of the cutting insert's side face is surface-contacted with the pocket's side wall.

Consequently, a space S is formed between the perpendicular wall 14-4 of the pocket 14 and the inclined side face 12-4 of the cutting insert 12. Under this condition, when a process for cutting the workpiece is performed, only some of force exerted to the cutting insert 12 is transmitted to the side wall 14-4 of the pocket 14, most of the force is not transmitted to the wall of the pocket.

As a result, a force is exerted excessively to the clamping screw 13 coupling the cutting insert 12 to the tool holder 11 so that the clamping screw 13 can be damaged or broken.

### SUMMARY

The present invention is conceived to solve the above-mentioned problems of the tool assembly.

One object of the present invention is to provide a reversible or “double-sided” cutting insert having a plurality of cutting edges formed thereon, and a tool assembly comprising the above cutting insert and a tool holder to which the cutting insert can be mounted securely.

Another object of the present invention is to provide a tool assembly in which side walls of each pocket formed on a tool holder are in surface-contact with side surfaces of a cutting insert to prevent a clamping screw from being damaged.

To achieve the above objects, a cutting insert according to the present invention comprises an upper face, a lower face, a central axial hole and a plurality of side faces connecting the upper face and the lower faces, each of the side faces being convexed in the lateral direction, round-shaped upper and lower cutting edges being formed at a border portion between the upper face and each of side faces and a border portion between the lower face and each of the side faces, respectively, each of the side faces comprising an axially dented portion formed between the upper cutting edge and the lower cutting edge, the axially dented portion being extended in a widthwise direction and being a flat face perpendicular to the upper and lower faces.

Here, each of the side faces comprises an upper inclined region inclined from the upper cutting edge to the axially dented portion and a lower inclined region inclined from the lower cutting edge to the axially dented portion. In the cutting insert of the present invention, each of the side faces comprises side inclined portions formed at both sides of the axially dented portion and inclined toward the adjacent side face.

In the meantime, each of the upper and lower faces may have an inclined portion formed at a periphery thereof and inclined toward the side face.

In addition, the reversible cutting insert according to the present invention may comprise three side faces having the same length and a groove may be formed between two adjacent side faces and extended in the axial direction.

A tool assembly according to the present invention comprises a tool holder on which a plurality of pockets are formed, and a plurality of cutting inserts, each of which is mounted in one of the pockets. In the tool assembly, the cutting insert comprises an upper face, a lower face, a central axial hole and a plurality of side faces connecting the upper face and the lower faces, each of the side faces being convexed in the lateral direction, round-shaped upper and lower cutting edges being formed at a border portion between the upper face and each of side faces and a border portion between the lower face and each of the side faces, respectively, each of the side faces having an axially dented portion formed between the upper cutting edge and the lower cutting edge, the axially dented portion being extended in a widthwise direction and being a flat face perpendicular to the upper and lower faces. Also, the pocket formed on the tool holder consists of a bottom face and at least two side walls, and the lower face of the cutting insert is supported by the bottom face of the pocket and the side faces are supported by the side walls the pocket.

At this time, the side wall of the pocket has a protruded flat portion formed thereon and the protruded flat portion is in surface-contact with the flat axially dented portion of the side face of the cutting insert.

The cutting insert and the tool assembly comprising the same according to the present invention have the following advantages.

Since a plurality of cutting edges are formed at both side edge portions of the upper face and the both side edge portions of the lower face of the cutting insert, it is possible to lengthen a life time of the expensive cutting insert.

In addition, the lower face and at least two side faces of the cutting insert are in surface-contact with the bottom face and side walls of the pocket, respectively, and so the cutting insert is securely and stably mounted in the pocket.

In the tool assembly according to the present invention, in addition, when the process for cutting the workpiece is performed, the force exerted on each cutting insert is entirely transmitted to the walls of the pocket, so an excessive force is not transmitted to the clamping screw, thus preventing the clamping screw from being damaged.

### BRIEF DESCRIPTION OF DRAWINGS

FIG. 1 is a partial perspective view of a conventional ball nose end mill.

FIG. 2 is a perspective view of a cutting insert shown in FIG. 1.

FIG. 3 is a sectional view taken along the line A-A in FIG. 1.

FIG. 4 is a partial perspective view of a ball nose end mill comprising a tool assembly according to the present invention.

FIG. 5 and FIG. 6 are upper perspective view and lower perspective view of a cutting insert shown in FIG. 4 according to one embodiment.

FIG. 7 is a sectional view taken along the line B-B in FIG. 5 and show a cutting insert together with a portion of a pocket formed on a tool holder.

FIG. 8 is a view showing a state in which one cutting insert is removed from a tool holder shown in FIG. 4 and showing an inner structure of a pocket formed on a tool holder.

FIG. 9 is a perspective view a cutting insert according to another embodiment of the present invention.

FIG. 10 is a partial perspective view of a tool holder to which a cutting insert shown in

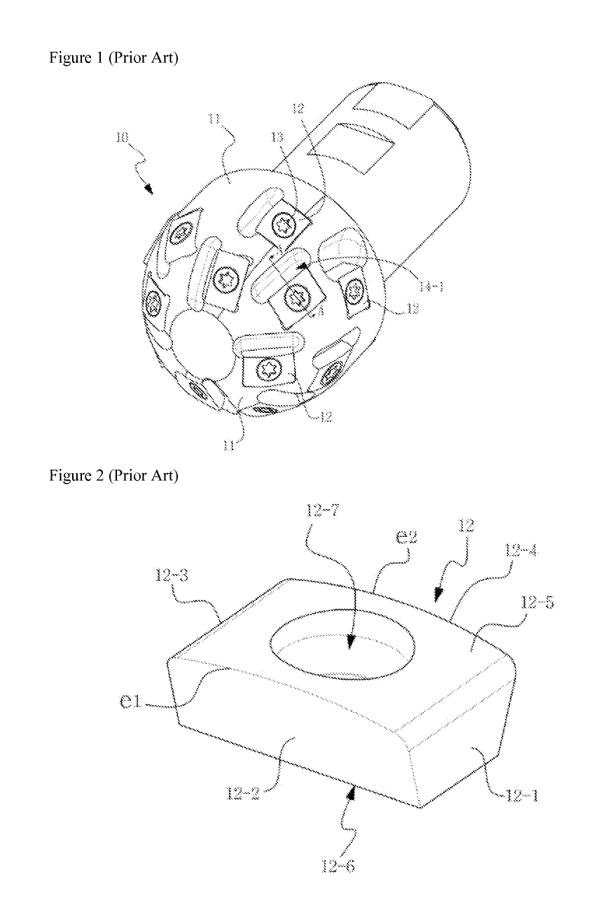

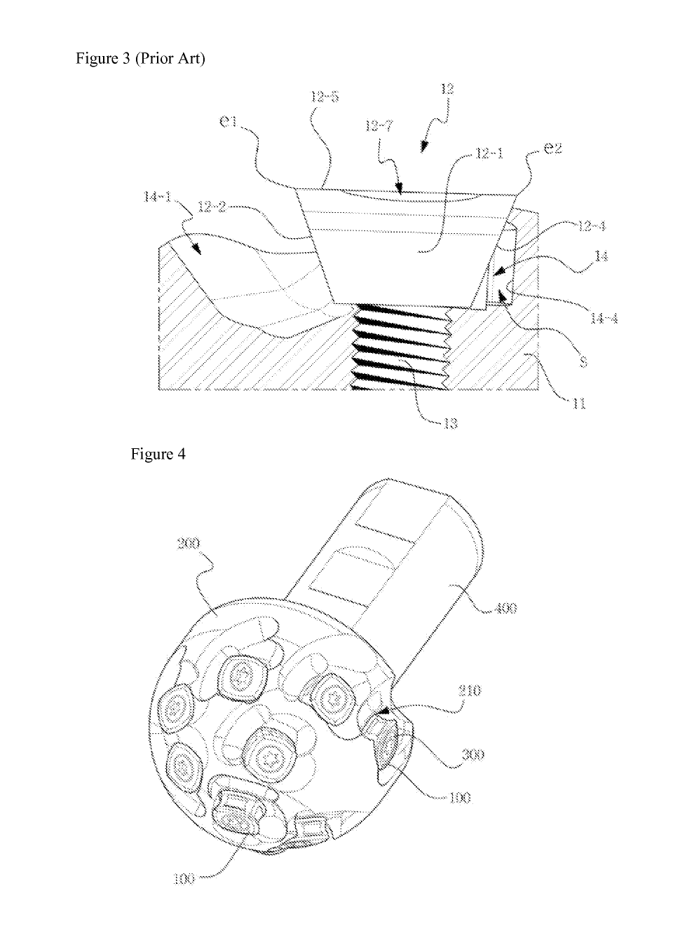

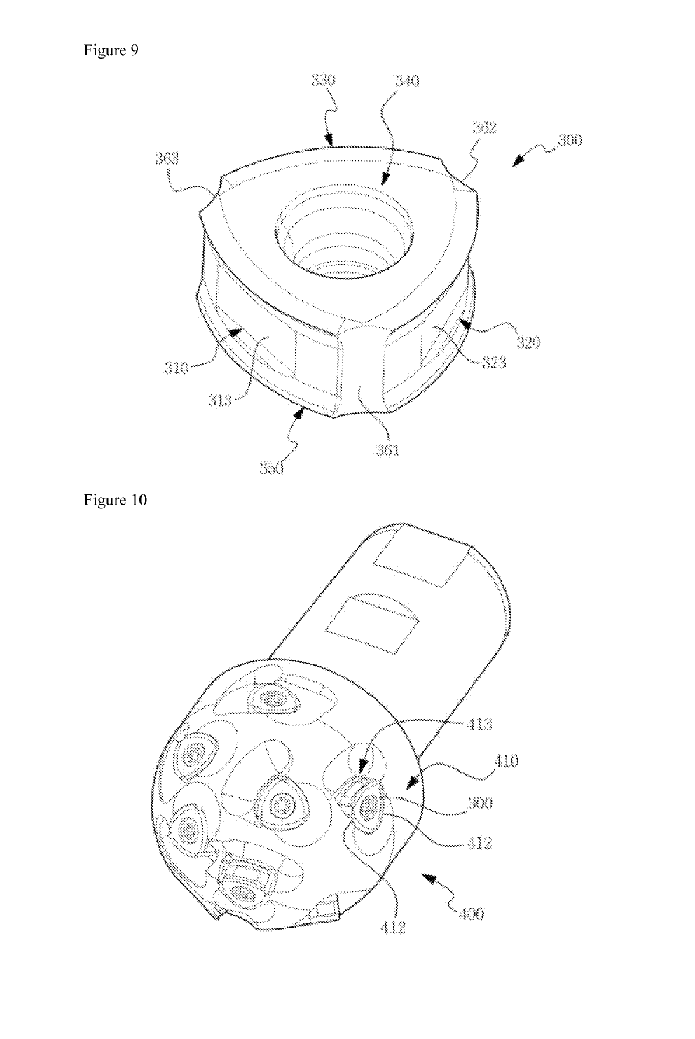

FIG. 9.

### DETAILED DESCRIPTION

Hereinafter, a cutting insert and a tool assembly comprising the same according to the present invention are described in detail with reference to the accompanying drawings. In the meantime, a tool assembly mounted to a ball nose end mill is described herein as an example. However, it will be apparent that a tool assembly according to the present invention can be applied to all the cutting tools comprising the cutting insert and the tool holder to which the cutting inserts are mounted.

FIG. 4 is a partial perspective view of a ball nose end mill comprising a tool assembly according to the present invention, the tool assembly according to the present invention comprises a spherical tool holder 200 and a plurality of cutting inserts 100 mounted to the tool holder 200. The reference numeral “400” indicates a shank coupled to the tool holder 200.

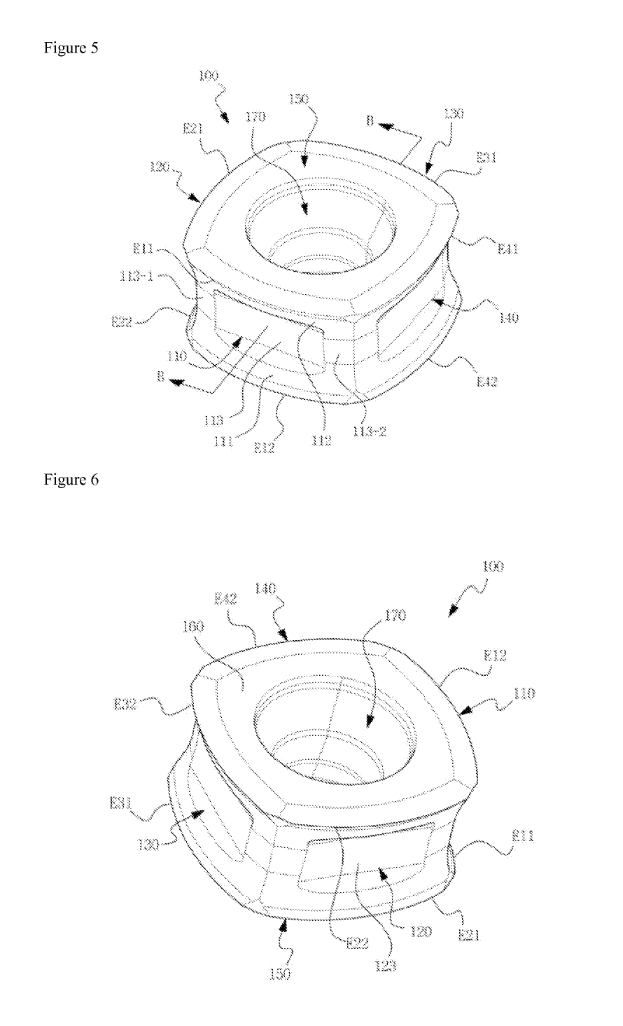

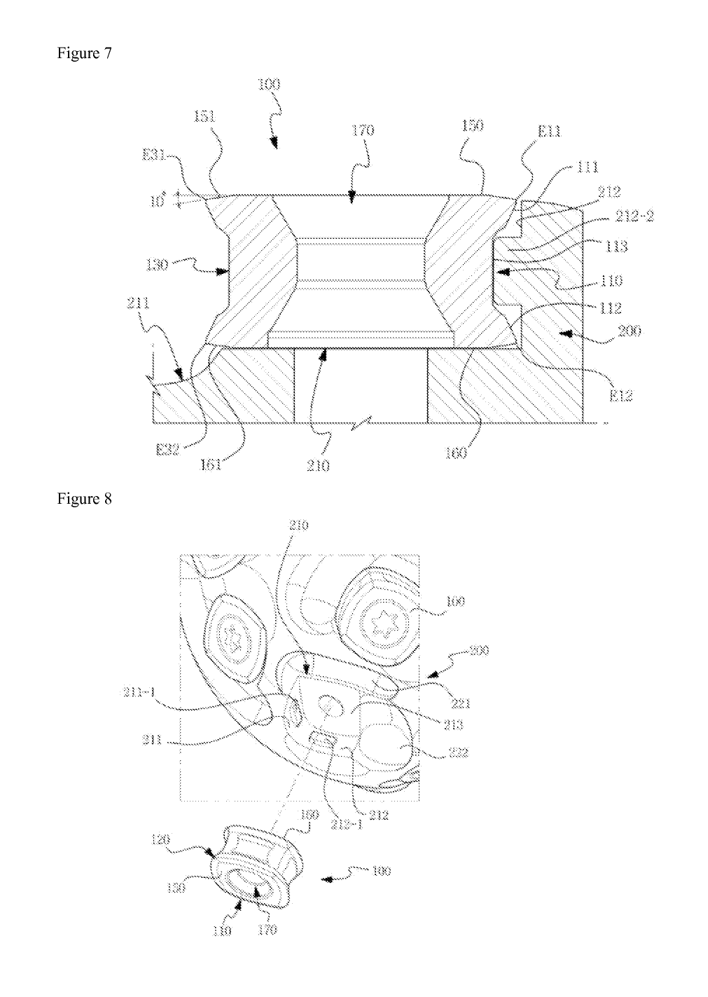

Structures of the tool holder 200 and each cutting insert 100 are described with reference to FIG. 5, FIG. 6 and FIG. 7.

FIG. 5 and FIG. 6 are upper perspective view and lower perspective view of the cutting insert 100 shown in FIG. 4. The cutting insert 100 according to one embodiment of the present invention comprises an upper face 150, a lower face 160, a plurality of side faces, that is, first to fourth side faces 110, 120, 130 and 140 connecting the upper face 150 and the lower face 160.

The cutting insert 100 has a central axial hole 170 passing a central axis of the upper face 150 and the lower face 160 and formed at a central portion thereof, and a clamping screw (300 in FIG. 4) passes through the central axial hole 170 and is then screw-coupled with a coupling portion formed on a bottom face of a pocket of the tool holder 200, and so the cutting insert 100 is fixedly mounted in the pocket.

As shown in FIG. 5 and FIG. 6, the side faces 110, 120, 130 and 140 are convexed (“outwardly bowed”) in the lateral direction and concaved in the axial direction. Accordingly, a border portion of the upper face 150 and each of the side faces and a border portion between the lower face 160 and each of the side faces act as rounded shaped upper and lower cutting edges E11, E21, E31, E41 and E12, E22, E32, E42 which are convexed outward.

In the cutting insert 100, in the meantime, portions of all the side faces 110, 120, 130 and 140 (substantially, axially dented portions described later) are perpendicular to the upper and lower faces 150 and 160, and portions of two opposite side faces, that is, the first and third side faces 110 and 130, and the second side faces 120 and the fourth side faces 140 are parallel to each other.

All the side faces 110, 120, 130 and 140 have the same shape, and so only a configuration of the first side face 110 of the cutting insert 100 is illustrated with reference to the FIG. 5 and FIG. 7 below.

FIG. 7 is a sectional view taken along the line B-B in FIG. 5. As described above, the first side face 110 is a curved face which is convexed outward, and the upper and lower cutting edges E11 and E12 are formed at an upper portion and a lower portion of the first side face 110, that is, border portions between the first side face 110 and the upper face 150 and between the first side face 110 and the lower face 160. The first side face 110 comprises an upper inclined region 111, a lower inclined region 112 and an axially dented portion 113 placed between the upper and lower inclined regions 111 and 112. The axially dented portion 113 has a groove shape extending in the widthwise direction.

The region between the upper cutting edge E11 and the axially dented portion 113 and the region between the lower cutting edge E12 and the axially dented portion 113, that is, the upper and the lower inclined regions 111 and 112 are formed as inclined faces which are inclined from the upper and lower cutting edges E11 and E12 toward the axially dented portion 113, respectively. Due to the above structure, the upper and lower cutting edges E11 and E12 having the positive rake angle are formed.

Preferably, the axially dented portion 113 is formed as a flat face perpendicular to the upper face 150 and the lower face 160. Here, the axially dented portion 113 is the central flat supporting face which becomes in surface-contact with a side wall of the pocket described later.

The first side face 110 further comprises first and second side inclined portions 113-1 and 113-2 formed on both sides of the axially dented portion 113 and inclined toward the adjacent second face 120 and the fourth side face 140, respectively, to allow chips generated in a cutting process to be moved smoothly.

In the meantime, the upper and lower faces 150 and 160 have peripheral inclined faces 151 and 161 formed at peripheries thereof and inclined toward the side faces 110, 120, 130 and 140. These peripheral inclined faces 151 and 161 have an inclination angle of approximately 10° Due to the above peripheral inclined faces 151 and 161, the upper and lower cutting edges E11, E21, E31, E41 and E12, E22, E32, E42 of the cutting insert 100 have an appropriate clearance angle.

On the spherical tool holder 200 shown FIG. 4 and constituting the ball nose end mill, a plurality of pockets 210 in which the cutting inserts 100 are mounted by clamping screws 300 are formed.

FIG. 8 is a view showing a state where one cutting insert is removed from the tool holder shown in FIG. 4 and showing a bottom face 213, side walls 211 and 212 constituting the pocket 210 and grooves 221 and 222 formed at a front portion and one side of the pocket 210.

The pocket 210 formed on the tool holder 200 has a shape and a dimension corresponding to those of the cutting insert 100, and the grooves 221 and 222 having a certain width, length and depth are formed on a front side and one side of the pocket 210, corresponding to two cutting edges (that is, the cutting edge corresponding to a workpiece).

Below, the structure in which the cutting insert 100 is mounted in the pocket 210 of the tool holder 200 in a state where the upper cutting edges E31 and E41 formed at upper ends of the third side face 130 and the fourth side face 140 correspond to the grooves 221 and 222 is illustrated with reference to FIG. 7 and FIG. 8. In the meantime, FIG. 7 shows the cutting insert 100 together with a portion of the pocket 210 formed on the tool holder 200.

When the cutting insert 100 is mounted fixedly in the pocket 210 through the clamping screw 300, the lower face 160 of the cutting insert 100 is supported by a bottom face 213 of the pocket 210, the second side face 120 is supported by the side wall 211 of the pocket 210 and the first side face 110 is supported by the rear side wall 212 of the pocket 210.

The side wall 211 and the rear side wall 212 of the pocket 210 are the regions corresponding to two side faces (for example, 110 and 120) of the cutting insert 100, and so it is preferably that the side walls 211 and 212 have a shape corresponding to that of the side face (for example, 110) of the cutting insert having the upper and lower inclined regions (for example, 111 and 112).

As shown in FIG. 8, a protruded flat portion 212-1 is formed on the side wall 212 of the pocket 210, and so the flat axially dented portion 113 of the first side face 110 of the cutting insert 100 is in surface-contact with the protruded flat portion 212-1 of the side wall 212 of the pocket 210.

In addition, a protruded flat portion 212-1 is formed on another side wall 211 of the pocket 210, and so the flat dented portion (123 in FIG. 6) of the second side face 120 of the cutting insert 100 is in surface-contact with the protruded flat portion 211-1 of the side wall 211 of the pocket 210.

Consequently, the lower face 160, the first and second faces 110 and 120 of the cutting insert 100 are in surface-contact with the bottom face 213, the side walls 211 and wall 212 of the pocket 210, respectively, and so the cutting insert 100 is securely and stably mounted in the pocket 210.

In addition, due to the pocket 210 and the cutting insert 100 having the above structures, when the process for cutting the workpiece is performed, the force exerted to the cutting insert 100 is entirely transmitted to the side walls 211 and 212 of the pocket 210, which are in surface-contact with the side faces 110 and 120, so an excessive force is not transmitted to the clamping screw 300 to prevent the clamping screw 300 from being damaged.

In particular, since a plurality of cutting edges (in FIG. 5 and FIG. 6, eight upper and lower cutting edges E11, E21, E31, E41 and E12, E22, E32, E42) are formed at the side edge portions of the upper face 150 and the side edge portions of the lower face 160 of the cutting insert 100, it is possible to lengthen a life time of the expensive cutting insert 100.

Here, although FIG. 5 and FIG. 7 illustrate the cutting insert having four side faces 110, 120, 130 and 140, the number of the side faces according to the present invention is not limited. That is, six (6) side faces or eight (8) side faces may be formed on the cutting insert. In this case, it is preferable to arrange the side faces such that two side faces are symmetrically opposite to each other with respect to a central axis hole.

FIG. 9 is a perspective view a cutting insert according to another embodiment of the present invention and shows a cutting insert having three (3) side faces. FIG. 10 is a partial perspective view of a tool holder 400 to which a cutting insert 100 shown in FIG. 9.

Except that the cutting insert 300 has three side faces 310, 320 and 330 meeting at angle of 60° that is, the cutting insert 300 has three side faces 310, 320 and 330 having the same length, the entire structure of the cutting insert 300 shown in FIG. 9 is the same as that of the cutting insert show in FIG. 5 and FIG. 6. On the other hand, each of the corner grooves 361, 362 and 363 is formed at a border portion between two adjacent side faces and extends in the axial direction.

As shown in FIG. 10, a tool holder 400 has pockets 410 having a triangle shape for mounting the cutting inserts 300 shown in FIG. 9 therein. That is, each pocket 410 is defined by a bottom face (not shown) and two side walls 412 and a portion 413 of the pocket is opened. Here, a flat protruded portion (not shown, but having the structure same as that as indicated 211-1 and 212-1 in FIG. 8) is formed on each side wall 412 of the pocket 410, and so the axially dented portions (for example, 313 and 323 in FIG. 9) formed on two side faces of the cutting insert 300 become in surface-contact with the flat protruded portions formed on two side walls 412 of the pocket 410 when the cutting insert 300 is mounted in the pocket 410.

In the meantime, when the cutting insert 300 is mounted in the pocket 410, the grooves (361 and 362 in FIG. 10) of the cutting insert 300 are partially exposed to an outside through the opened portion 413 of the pocket 410.

In the tool holder 400 having the above structure, two side walls 412 of the pocket 410 are in contact with two side faces (for example, 310 and 320) of the cutting insert 300 through the flat protruded portions formed on two side walls 412 of the pocket 410 and the axially dented portions (for example, 331 and 323) formed on the side face (for example, 310 and 320) of the cutting insert 300, and so it is possible to mount stably and securely the cutting insert 300 and a cutting force exerted to the cutting insert 300 during a cutting process for the workpiece is entirely transmitted to the side walls 412 of the pocket 410 to prevent the clamping screw from being damaged.

The scope of the present invention is not limited to the embodiments described above and the scope of the present invention is determined and defined only by the appended claims. Further, those skilled in the art can make various changes and modifications thereto without departing from its true spirit. Therefore, various changes and modifications obvious to those skilled in the art will fall within the scope of the present invention.

What is claimed is:

1. A reversible cutting insert, comprising an upper face, a lower face, a central axial hole and a plurality of side faces connecting the upper face and the lower faces,
each of the side faces being convexed in the lateral direction,
round-shaped upper and lower cutting edges being formed at a border portion between the upper face and each of side faces and a border portion between the lower face and each of the side faces, respectively,
each of the side faces comprising an axially dented portion formed between the upper cutting edge and the lower cutting edge, the axially dented portion extending in a widthwise direction and having a flat face perpendicular to the upper and lower faces.

2. The reversible cutting insert according to claim 1, wherein each of the side faces comprises an upper inclined region inclined from the upper cutting edge to the axially dented portion and a lower inclined region inclined from the lower cutting edge to the axially dented portion.

3. The reversible cutting insert according to claim 2, wherein each of the side faces comprises side inclined portions formed at both sides of the axially dented portion and inclined toward an adjacent side face.

4. The reversible cutting insert according to claim 3, wherein each of the upper and lower faces has an inclined portion formed at a periphery thereof and inclined toward one of the side faces.

5. The reversible cutting insert according to claim 4, comprising:
exactly three side faces having the same length, and
a corner groove formed between each pair of adjacent side faces and extending in the axial direction.

6. The reversible cutting insert according to claim 4, comprising:
exactly four side faces having the same length.

7. The reversible cutting insert according to claim 1, wherein each of the side faces comprises side inclined portions formed at both sides of the axially dented portion and inclined toward an adjacent side face.

8. The reversible cutting insert according to claim 1, wherein each of the upper and lower faces has an inclined portion formed at a periphery thereof and inclined toward one of the side faces.

9. The reversible cutting insert according to claim 1, comprising:
exactly three side faces having the same length, and
a corner groove formed between each pair of adjacent side faces and extending in the axial direction.

10. The reversible cutting insert according to claim 1, comprising:
exactly four side faces having the same length.

11. A tool assembly comprising:
a tool holder on which a plurality of pockets are formed, and
a plurality of reversible cutting inserts, each mounted in one of the plurality of pockets, wherein:
each cutting insert comprises an upper face, a lower face, a central axial hole and a plurality of side faces connecting the upper face and the lower faces, each of the side faces being convexed in the lateral direction, round-shaped upper and lower cutting edges being formed at a border portion between the upper face and each of side faces and a border portion between the lower face and each of the side faces, respectively, each of the side faces having an axially dented portion formed between the upper cutting edge and the lower cutting edge, the axially dented portion extending in a widthwise direction and having a flat face perpendicular to the upper and lower faces,
each pocket has a bottom face and at least two side walls, and
the lower face of the cutting insert is supported by the bottom face of the pocket and at least two of the cutting insert's side faces are supported by corresponding at least two side walls of the pocket.

12. The tool assembly according to claim 11, wherein each side wall of the pocket has a protruded flat portion formed thereon and the protruded flat portion is in surface-contact with the flat axially dented portion of one of the side faces of the cutting insert.

13. A reversible cutting insert suitable for mounting in a ball nose end mill having a plurality of insert pockets, the cutting insert comprising:
an upper face, a lower face, a central axial hole and a plurality of side faces connecting the upper face and the lower faces,
each of the side faces being convexed in the lateral direction,
round-shaped upper and lower cutting edges being formed at a border portion between the upper face and each of side faces and a border portion between the lower face and each of the side faces, respectively,
each of the side faces comprising an axially dented portion formed between the upper cutting edge and the lower cutting edge, the axially dented portion extending in a widthwise direction and having a flat face perpendicular to the upper and lower faces, wherein:
each of the side faces comprises an upper inclined region inclined from the upper cutting edge to the axially dented portion and a lower inclined region inclined from the lower cutting edge to the axially dented portion;
each of the side faces comprises side inclined portions formed at both sides of the axially dented portion and inclined toward an adjacent side face; and
each of the upper and lower faces has an inclined portion formed at a periphery thereof and inclined toward one of the side faces.

14. The reversible cutting insert according to claim 13, comprising:
exactly three side faces having the same length, and
a corner groove formed between each pair of adjacent side faces and extending in the axial direction.

15. The reversible cutting insert according to claim 13, comprising:
exactly four side faces having the same length.
